(19) United States
(12) Patent Application Publication
(10) Pub. No.: US 2011/0083761 A1
(43) Pub. Date: Apr. 14, 2011

(54) LIQUID IRRIGATION SYSTEM

(76) Inventor: George Evans, Long Drax near Selby (GB)

(21) Appl. No.: 12/997,381

(22) PCT Filed: May 6, 2009
(86) PCT No.: PCT/GB09/01119

§ 371 Date: Dec. 10, 2010

(30) Foreign Application Priority Data
May 6, 2008 (GB) 0808164.8
Aug. 19, 2008 (GB) 0815092.2
Mar. 10, 2009 (GB) 0904119.5

(51) Int. Cl. A01G 27/00

(52) U.S. Cl. 137/565.01

(57) ABSTRACT

An apparatus for use in the application of liquid onto a body of matter to provide a watering effect and hence maintain the condition of the body of matter so as to encourage plant growth. The system includes a liquid reservoir, and a pump means and irrigation means so as to allow liquid to be moved from the reservoir and be dispensed onto the body of matter. The operation of the system to dispense liquid can be proportional to at least one environmental component such as the amount of sunlight such that when the body of matter is likely to be drier the system is operated to dispense more liquid.

### CROSS-REFERENCE TO RELATED APPLICATIONS

This application is the national stage of International Application No. PCT/GB2009/00119, which was filed on May 6, 2009, which claims the benefit of United Kingdom Patent Application Serial No. 0808164.8, which was filed on May 6, 2008, United Kingdom Patent Application Serial No. 0815092.2, which was filed on Aug. 19, 2008, and United Kingdom Patent Application Serial No. 0904119.5, which was filed on Mar. 10, 2009.

### FIELD OF THE INVENTION

The invention to which this application relates is to an improved irrigation system which allows the controlled application of liquid such as water or hydroponic solution to a body of matter such as soil or other plant growing medium so as to reduce the risk of plants in said body of liquid being damaged or dying in dry or drought conditions.

### BACKGROUND OF THE INVENTION

It is well known that liquid is required to be added to the matter in which plants are growing, particularly during hot or prolonged dry parts of the year in order for the plants to survive and/or grow to their full potential. The application of liquid can be performed via the relatively simple process of applying liquid from a hose or watering can or by using relatively complex irrigation systems. It is also known, in times of liquid shortage, to use rainwater, rather than water from a mains supply, with the rain water being collected in butts from which the same can be applied or, alternatively, can be supplied via piping to the area of application.

At worst, the application of the liquid can be random and relatively haphazard or there may be relatively complex timing systems employed to ensure that liquid is applied by irrigation systems for a period of time. However, these timing systems typically apply liquid regardless of prevailing weather conditions and therefore on occasion, the plants may be overwatered or on other occasions, under watered. It is also found that the provision of these watering systems with control systems become relatively expensive to install and therefore typically only used by professional or keen amateur gardeners.

### SUMMARY OF THE INVENTION

The aim of the present invention is to provide a system which allows improved utilization of liquid and, furthermore, allows the liquid to be applied in a more efficient and controlled manner with respect to when the liquid is actually required by the plants with regard to the environmental conditions.

In a first aspect of the invention, there is provided a liquid application system, said liquid application system including a reservoir in which liquid can be collected, a body of matter in which at least one plant can be planted to grow and supply means to allow liquid to be selectively removed from the reservoir to be applied to the body of matter and wherein the application of liquid occurs with respect to the condition of a power supply connected to at least the supply means.

In one embodiment the application of liquid occurs with reference to the condition of the power supply, said power supply charged by use of at least one component of the environment. In one embodiment the component is any or any combination of wind and/or light.

Typically a number of plants will be planted in the body of matter.

In one embodiment, the supply means includes at least one pump provided to pump liquid from the reservoir onto the body of matter.

In one embodiment, the power source comprises one or more rechargeable batteries. In one embodiment mains or non rechargeable batteries may also be provided or provided as an alternative to rechargeable batteries.

In one embodiment therefore the operation of the pump and hence supply of liquid is dependent on there being sufficient charge in the batteries at any given time so as to operate the pump.

In one embodiment control means are provided alternatively to, or in addition to, the power supply, said control means influencing or allowing complete control of the condition of the power supply in terms of switching the same on or off and/or controlling the condition of the power supply in terms of time of operation and/or level of charge provided to operate the system.

In one embodiment, where rechargeable batteries are provided, the same can be charged using a natural resource such as wind, solar energy or the like, but, preferably, utilises solar energy via one or more solar panels connected to the power source. An advantage of using solar power is that, firstly, the same is an effective means of charging the power sources and also, generally, when the panels are being charged by solar power so, at the same time, the general and environmental conditions will be dry as the sun is shining This therefore means that it is likely that the watering of the body of soil will be required due to the dry and/or hot environmental conditions. Thus, as the shining of the sun represents the opportunity for the solar panels to be charged so there is provided a proportional link between the available power to apply the liquid and the requirement for the liquid to be applied.

In one embodiment, the reservoir of liquid is located underneath the body of matter and is separated therefrom by a permeable membrane which allows excess liquid which falls onto the matter by application via the system, and/or precipitation, to pass through the matter and membrane and into the reservoir to be stored therein for subsequent use.

In one embodiment, the reservoir incorporates a liquid permeable substance such as perlite, an aggregate holding liquid in the interstices or, alternatively, only liquid is held within the reservoir.

Typically, at least one reservoir tube is provided in the reservoir and via which liquid can leave the reservoir to be pumped onto the body of the matter.

In one embodiment, there is provided a pump mounted with a connecting tube which is received by the reservoir tube so as to allow liquid to be pumped from the reservoir via the pump and then applied to the body of matter. Typically the pump is mounted towards the entry at the lowest part of the tube and therefore sits within the liquid of the reservoir and is therefore self priming. Alternatively a positive displacement pump can be used which need not be positioned at the entry to the pump tube.

In one embodiment, the application of the liquid from the pump to the body of matter, is via an irrigation system.

Typically the control circuitry, switch devices and at least one solar panel, along with the power sources, are located on the pump tube and in or on a housing provided on said pump tube.

In one embodiment, there is provided at least one means by which liquid held within the reservoir can be taken from the reservoir separately.

In one embodiment, the body of matter and the reservoir are located such as to form a raised bed.

In one embodiment the raised bed can receive thereon, further components such as for example a cloche comprising a series of spaced support members which support a sheet material therebetween. Preferably, the sheet material is located with regard to the raised bed such that any precipitation which falls on the sheet material, slides down the same and into the soil into the raised bed thereby passing towards the reservoir.

Preferably, the pump tube, pump and housing can be selectively located onto a reservoir tube of any of a range of reservoirs. This therefore means that there may be a number of reservoirs with a number of reservoir tubes connected thereto but only one or a lesser number of pump tubes, pumps and housing need to be provided thereby allowing the user to selectively position the pump tube in the location where it is most required at any given time and still ensure that watering can be achieved. This also ensures that the system can be more economical to buy as the most expensive part typically will be the pump tube. The provision of solar power to allow the pump to be operated means that the same can be positioned anywhere and need not be close to a mains electricity supply.

In a further aspect of the invention, there is provided a liquid application system for plants, said system comprising a means for providing power, control means, pump and a tube wherein said tube is placeable into a liquid reservoir to allow liquid from the reservoir to be pumped therefrom plant.

In on embodiment the means for providing power is any or any combination of a mains power source, or a solar panel or windmill provided to charge one or more rechargeable batteries.

Typically the control means, power source and pump are provided as an integral unit, along with, if provided the solar panel.

In one embodiment, the pump is a submersible pump.

In one embodiment, the reservoir tube and/or pump tube includes a filter device so as to minimise the particles which pass through the same and which may otherwise cause blockage of the pump or irrigation system supplied thereby.

In a further aspect of the system there is provided a liquid application system, said system including a reservoir for the collection of liquid to be dispersed to provide a watering effect, a pump connected to move liquid from the reservoir via a pipe and wherein the system further includes a power supply and means to control the system such as to control the application of the liquid. In one embodiment the pipe includes at least one sensor mounted therein, the condition of the sensor varying dependent upon whether the same is in contact with the liquid at that instant.

Typically the sensor detects a current which is monitored by control means and the level of the current is indicative of whether or not the sensor is in the liquid. This, in turn, allows the control of the switching on and off of the pump and hence the liquid supply to the liquid application means.

In one embodiment a plurality of sensors are provided, said sensors provided at spaced locations on the downpipe.

In one embodiment the sensor can be used to detect a condition of the liquid. In one embodiment the detection is the presence or otherwise of a constituent of the liquid, such as, for example, the fertilizer content. This indication can be used to generate an indication of the condition to the user and the user can react to the same accordingly and alter the condition of the liquid as appropriate.

In one embodiment one or more solar panels are used to charge one or more batteries which, in turn, supply electrical power to drive the pump.

In one embodiment controls means, such as a potentiometer, are provided to control the amount of solar power supplied to the batteries, and hence power to the pump so as to allow the control of the operation of the same.

In one embodiment the control is adjustable by the user between a maximum in which all solar power is used to charge the batteries and hence power the pump, and a minimum in which only part of the possible battery charge is used, thereby limiting the usage of the pump and hence the watering effect. This, in turn, allows direct control of the operation of the pump and the extent of watering which occurs. It also allows the system to be more adaptable, for example, the control of the pump allows the system to be capable of being used in water butts. In one embodiment the pump is turned on by a timer, and turned off by the monitored voltage dropping to a predetermined level.

In one embodiment when the system is used in certain apparatus, such as, for example, in water butts, an anti-siphoning device is fitted for the pump in order to allow the same to operate effectively.

In a further aspect of the invention there is provided apparatus for moving a liquid from a liquid reservoir to be dispersed on and/or into a body of matter, said apparatus including a portion, at least part of which is positioned in communication with the body of liquid in said reservoir, a pump operable to draw liquid from the reservoir via the said portion to dispersal means and control means to control the operation of the pump.

Typically said portion defines a passage along which the liquid passes to the dispersal means.

In one embodiment the pump acts to move the liquid to and through the dispersal means. The dispersal means can in one embodiment be an irrigation system.

In one embodiment, the control means, a power source and the pump are located within a common housing.

In one embodiment the power source includes at least one solar panel mounted externally of the housing and batteries, at least partially charged by the solar panel, mounted within the housing.

In a further aspect of the invention there is provided apparatus for moving liquid from a reservoir to be selectively dispensed onto a body of matter, wherein the apparatus is operable such that the amount of liquid which is dispensed is proportional to the condition of at least one component of the environment in the vicinity of the apparatus.

In one embodiment the said environmental component is the amount of sunshine and/or predefined light conditions to which at least part of the apparatus is exposed.

In one embodiment the said part of the apparatus which is exposed to the sunlight and/or predefined light conditions (hereinafter referred to as sunlight in a non-limiting manner) includes at least one solar panel thereon and this, in one embodiment, is provided as an integral part of the assembly or can be selectively detached therefrom so as to be positioned in improved light conditions with respect to the location of use of the remainder of the assembly.

In one embodiment, the more sunshine or more light to which the said part is exposed then the more liquid is dispersed by the system which is what would normally be desired as the greater amount of sunlight then the greater the drying effect on the body of matter onto which the liquid is to be dispensed and hence the greater the need for liquid.

In one embodiment the proportional link between sunlight and operation of the apparatus can be adjusted by the user to suit specific requirements, such as the type of plants grown in the body of matter at that time.

In one preferred embodiment of the invention, all the main components are contained within a single integrated housing to facilitate ease of set-up and use, and includes a solar panel integrated and linked to charge rechargeable batteries.

In one embodiment, in operation, when there is sufficient charge in the batteries, the pump is started up and continues to run until the battery voltage drops to a predetermined level. The more sunshine there has been, the longer this will take and hence the longer period of operation of the pump.

As a result the watering effect is proportional to sunshine, as the operation of the pump to displace the liquid from the reservoir to the dispersal means is required using control means and indication means on the housing. Also, via the control means, the user can adjust the length of time of operation of the pump and/or the proportion of sunshine which is collected and used to charge the batteries. Typically, there are four levels of user selectable operation and an off setting. For example, at the highest setting, on a bright day, the pump will run about one third of the time. At the lowest setting this drops to about 2% of the time. Whichever setting is used, the amount of watering still remains proportional to sunshine but the user is able to adjust output according to their requirements.

It should also be appreciated that reference herein to sunshine can also mean light conditions which are sufficiently bright (even though the sun may not be exposed) so as to enable the solar panel to operate to charge the batteries.

### BRIEF DESCRIPTION OF THE DRAWINGS

Specific embodiments of the invention will now be described with reference to the accompanying drawings wherein;

FIGS. 1 a-c illustrate a raised bed in accordance with one embodiment of the invention;

FIG. 2 illustrates an alternative form of bed in accordance with the invention;

FIG. 3 illustrates a pump tube in accordance with one embodiment of the invention; and

FIG. 4 illustrates a schematic diagram of the system in accordance with another embodiment of the invention.

### DETAILED DESCRIPTION

Referring to the drawings, the present invention will now be described in detail with reference to the disclosed embodiment.

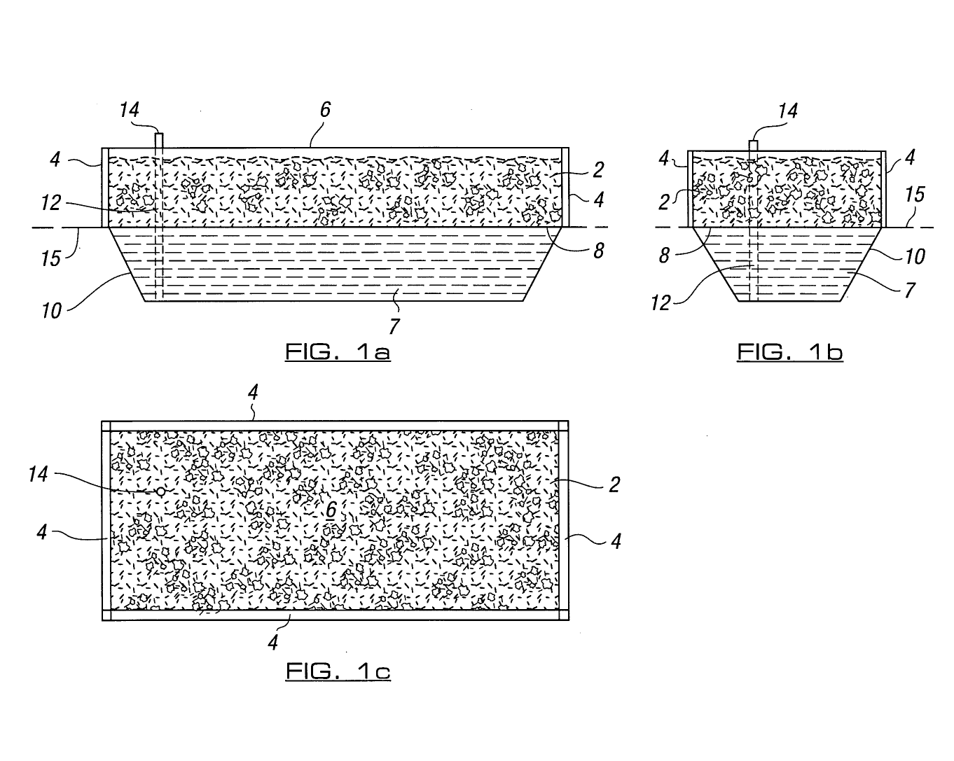

The body of matter onto which the liquid is to be dispensed by the system in accordance with the invention can take many forms. An example of one type is now shown for the purposes of illustration of the invention. In this case the body of matter is in the form of a raised bed which is a well established form for use in growing plants because they offer many advantages over growing plants in the ground. A raised bed in accordance with one embodiment of the invention is shown in FIGS. 1 a-c and comprises a body of matter in the form of soil 2 which is held in position via frame 4. The top surface 6 is exposed to sun and rain although, in one embodiment, a cloche can be positioned over the same to improve or increase growing. In this embodiment, underneath the body of matter such as soil and/or compost is a reservoir 7 in which liquid such as rainwater is held. The reservoir is lined by waterproof membrane 10 and the soil is separated from the reservoir via a liquid permeable lining 8. Thus, liquid which falls onto the soil or comes into the soil from the outer surface of the cloche or furthermore has previously been applied by the system, passes through the body of soil, through the permeable membrane and into the reservoir. Alternatively liquid from rainwater run-off, perhaps from a roof, may be used to fill the reservoir via a rain-saver device.

At least one reservoir tube or portion 12 is provided which passes from the reservoir to an entrance 14.

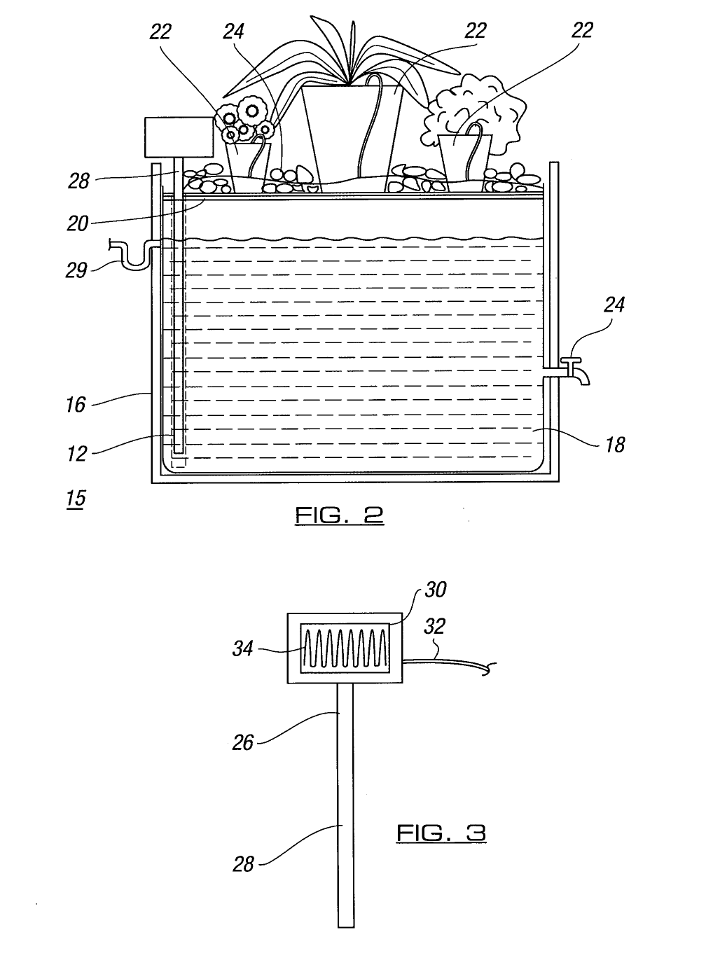

The location of the reservoir may be underground as shown in FIGS. 1 a-c. This reservoir may extend to a single body of matter such as a raised bed, or may extend beneath several. Alternatively, it may be above ground level as is shown in FIG. 2 in which in this case, there is provided a butt 16 with the lower part being the reservoir 18 which receives liquid from for example a liquid saving device 29. A support shelf 20 separates the reservoir 18 from the bodies of soil in the plant pots 22 and other media 24 which is provided on top the support shelf. In this case, there is again provided the reservoir tube 12 to take liquid from the reservoir but furthermore, there is provided other means in the form of a tap 24 which allow liquid to be taken from the reservoir for other purposes.

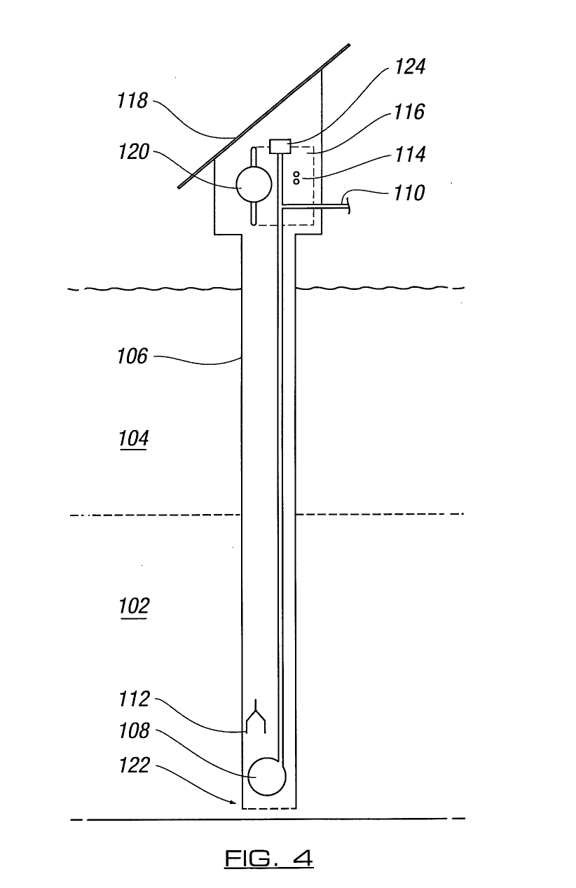

FIG. 3 illustrates a pump tube 26 in accordance with one embodiment of the invention which comprises a tube portion 28 which is provided to be received in the reservoir tube 12 as shown in FIG. 2. Also provided in the pump tube 26, is a submersible pump (not shown), located typically at the entry into the tube and hence in the liquid of the reservoir and connected to pump liquid from the reservoir to housing 30 and then onwards to an exit 32 to which, for example, an irrigation system (not shown) can be connected to thereby apply liquid onto the body of soil at the required locations. Also provided on the housing, is a solar panel 34 provided to take energy from the sun or generally light conditions and to charge a power source provided within the housing 30 which in turn, when there is sufficient power and voltage in the power sources, causes the operation of the pump.

It will therefore be appreciated that the pump tube can be selectively positioned in any of the reservoir tubes 12 which are provided at a particular location or alternatively, one pump tube can be provided for each reservoir tube.

Typically the housing 30 will be provided with a control means to at least allow the system to be switched on and off. However the control means may also be provided to allow a timer facility for operation of the system and/or monitoring of the level of available power from the power supply.

Typically the batteries in the housing are used to regulate the voltage from the solar panel to a voltage suitable for the pump. The batteries are also used to accumulate energy from the solar panel and deliver power to the pump as required to control the volume of watering. In one embodiment alternative or additional power sources may be utilised.

In one embodiment a float is located in the pump tube and when the liquid level is sufficiently high in the tube, the float rises and activates a microswitch situated in the control box. The movement of the float is conveyed to the microswitch via a plastic cable, which runs along the centre of the tube. Typically the microswitch is provided to only allow the pump and solar panel to operate when there is sufficient liquid available.

Referring to FIG. 4 there is shown a system in accordance with another embodiment of the invention, said system including a liquid reservoir 102 positioned below a body of soil 104 in which plants can be grown. The reservoir is connected to the area above the soil by a pipe 106 which is connected to a pump 108. The pump is provided to be operated to draw liquid from the reservoir and upwards along the pipe to a liquid application irrigation means 110 which allows the liquid from the reservoir to be dispensed onto the body of soil 104 to water the same.

In accordance with this embodiment there is provided at least one sensor 112 in the pipe. The sensor is provided to detect levels of electrical current and is connected to an electrical control circuit. When the sensor is within the liquid in the pipe, i.e. liquid is present, the current which is sensed is different to that when the sensor is not in the liquid. The difference can be used to provide a means of switching the pump off when no liquid is present and on when the liquid is detected.

The sensor can also be used, or another sensor can be provided, to detect the condition of the liquid. For example, in one embodiment, the sensor can detect the presence of fertilizer in the liquid and the percentage present. This reading can in turn be indicated, via a visual indication 114, to the user of the system, who can decide whether or not to add fertilizer to the liquid. The visual indication can also be used to indicate the status of the pump and/or overall system.

The pump is typically powered via batteries 116 which are charged via solar panel 118. There is provided between the solar panel 118 and batteries 116, a potentiometer 120, which can be adjusted by the user to alter the extent to which the energy from the solar panel is used to charge the batteries. The detected or available degree of charge of the batteries can in turn be used to control the operation of the pump, in terms of the length of time of operation, i.e., the less charge then the less operating time of the pump and less liquid application which will occur. Thus the potential uses of the system can be increased due to the ability to control the usage of the pump. In certain uses it can be useful to provide an anti-siphoning device 124 as part of the device, as shown in the Figure.

An inlet filter cap 122 can also be provided to prevent the ingress of foreign matter into the downpipe 106 and hence prevent the potential blockage of the pump or irrigation system.

In a further embodiment of the invention, not shown, the pump can be connected to the reservoir, such as a water butt, by a portion such as a tube or pipe. A filter body is typically fitted to the end of this tube and also acts as a weight to hold it in the liquid in the reservoir. The tube can be connected to the pump by suitable connectors such as by push-fit rubber or elastomer connectors. Similar push fit connectors can be used to connect the dispenser, such as an irrigation tube, which can lead to a dispersal means such as a drip irrigation system.

The pump employed can be of a positive displacement type in any of the embodiments. This means that the apparatus is capable of raising liquid to a relatively high level above the reservoir such as for example, high enough to irrigate a body of matter such as hanging baskets mounted at a height, such as up to 3 metres, above the reservoir. It also means that where the irrigation means are lower than the liquid source, siphoning is prevented.

The control means housing can be fitted with a water-proof jack plug to allow connection to an optional remotely positioned solar panel for use remotely from the housing when the positioning of the pump is, by necessity, in shade.

The housing may be fixed to the side of the reservoir, or to the pipe, or a nearby support using an optional bracket. The bracket is designed to take a small padlock to secure the unit. While the pump is in position it is impossible to reach the fixings holding the bracket.

In a further embodiment a smaller solar panel, sized to provide the optimum power for its purpose, is employed, rather than using a potentiometer to reduce charging of the batteries.

There is therefore provided a system which can be utilised to save liquid and store the same for subsequent use as required. Furthermore the user of the system can be confident that the liquid will be applied when it is required with respect to the weather or environmental conditions at that time. This is due to the fact that the system can be more likely to, or be controlled to, operate in dry weather as a result of the greater level of recharging of the power sources which is possible at that time as a result of the light conditions being more favourable such as when the sun is shining. This, in turn, means that when power is available from the recharged batteries the system is capable of operating to pump liquid from the reservoir and through the system to be dispensed. Alternatively, when the light conditions are relatively poor, such as when it is cloudy, the power sources will not be as readily recharged and the system is less likely to be able to operate. However as, when it is cloudy it is more likely to have rained, there is less need for the system to be operated to dispense liquid. It should also be noted that additional or alternative power sources can be provided to allow the system to still be operated even when the environmental conditions are not favourable to allow recharging, thereby allowing dry but relatively poor light environmental conditions to be dealt with by still allowing watering to occur via operation of the system.

It should also be noted that the reference to a liquid reservoir throughout the description should be interpreted as any source of the liquid and may include a body of water which is stored in a tank or butt or a pond or may be a mains supply of water to which the system is connected.

1. A liquid application system, comprising:
a reservoir in which liquid can be stored;
a body of matter in which at least one plant can be grown; and
a pump for selectively pumping liquid from the reservoir to be applied to the body of matter, wherein the application of liquid occurs with respect to the condition of a power supply connected to at least the supply means.

2. (canceled)

3. A system according to claim 1, wherein the power supply comprises one or more rechargeable batteries, and the operation of the pump and hence supply of liquid is dependent on the charge in the batteries.

4-5. (canceled)

6. A system according to claim 1 wherein there is a proportional link between the available power to apply the liquid and the requirement for the liquid to be applied.

7. A system according to claim 1 wherein the reservoir is located underneath the body of matter and is separated therefrom by a permeable membrane which allows liquid to pass through the membrane and into the reservoir to be stored therein for subsequent use.

8. A system according to claim 7 wherein the reservoir incorporates a liquid permeable substance.

9. A system according to claim 1 wherein at least one connecting tube is provided in the reservoir and via which liquid can leave the reservoir to be pumped onto the body of matter.

10. A system according to claim 9 wherein the pump is connected to the connecting tube so as to allow liquid to be pumped from the reservoir via the pump and then applied to the body of matter.

11. A system according to claim 1 wherein the application of the liquid from the pump to the body of matter, is via an irrigation system.

12. A system according to claim 9, further comprising:
a housing having the power supply disposed therein; and
control circuitry disposed within the housing.

13. A system according to claim 12, further comprising:
at least one solar panel that is positioned on the housing.

14. A system according to claim 12, wherein the housing is mounted on a tube which can be received by the connecting tube.

15-26. (canceled)

27. Apparatus for moving a liquid from a liquid reservoir to be dispersed on and/or into a body of matter, said apparatus including a portion, at least part of which is positioned in communication with the body of liquid in said reservoir, a pump operable to draw liquid from the reservoir via the said portion to dispersal means and control means to control the operation of the pump, wherein the control means, a power source, and the pump are located within a common housing.

28. Apparatus according to claim 27 wherein said portion defines a passage along which the liquid passes to the dispersal means, and the pump acts to move the liquid to and through the dispersal means.

29-30. (canceled)

31. Apparatus according to claim 27 wherein the power source includes at least one solar panel mounted externally of the housing and batteries which are at least partially charged by the solar panel, mounted within the housing.

32. Apparatus for moving liquid from a reservoir to be selectively dispensed onto a body of matter, wherein the apparatus is operable such that the amount of liquid which is dispensed is proportional to the condition of at least one component of the environment in the vicinity of the apparatus.

33. Apparatus according to claim 32 wherein the at least one component is the amount of sunshine and/or predefined light conditions to which at least part of the apparatus is exposed.

34. Apparatus according to claim 33 wherein the said part of the apparatus which is exposed to the sunlight and/or predefined light conditions includes at least one solar panel thereon.

35. Apparatus according to claim 34 wherein the solar panel is provided as an integral part of the assembly.

36. Apparatus according to claim 34 wherein the solar panel can be selectively detached therefrom so as to be positioned in improved light conditions with respect to the location of use of the remainder of the assembly.

37. Apparatus according to claim 33 wherein the proportional link between sunlight and operation of the apparatus can be adjusted by the user.
